(19) United States
(12) Patent Application Publication
(10) Pub. No.: US 2025/0139418 A1
(43) Pub. Date: May 1, 2025

(54) GENERATION OF STATISTICALLY FAIR TRAINING DATA

(71) Applicant: International Business Machines Corporation, Armonk, NY (US)

(72) Inventors: Carolyn Saplicki, New York, NY (US); Mitali Bante, Jersey City, NJ (US); Rahul Agarwal, Jersey City, NJ (US); Tushar Agrawal, New York, NY (US)

(21) Appl. No.: 18/498,091

(22) Filed: Oct. 31, 2023

(51) Int. Cl. G06N 3/0475; G06N 3/047

(52) U.S. Cl. CPC G06N 3/0475; G06N 3/047

(57) ABSTRACT

A computer-implemented method to generate training data with increased fairness. The method includes identifying a set of training data comprising at least one independent variable and dependent variable. The method includes analyzing the set of training data to identify correlations between the independent and the dependent variables. The method further includes identifying at least one correlation between the one or more independent variable and the dependent variable. The method includes calculating a fairness score for each first independent variable against the dependent variable. The method further includes creating, based on the analyzing, a fairness profile for the set of training data. The method also includes generating, by a generative adversarial network (GAN) and based on the set of training data and the fairness profile, a set of synthetic training, where the GAN is configured to increases the fairness score for each variable with a disparate effect score above a threshold.

### BACKGROUND

The present disclosure relates to artificial intelligence, and, more specifically, creation of a fairness testing dataset.

Machine learning is a discipline that attempts to cause computing devices to analyze data and identify one or more conclusions and or perform one or more tasks based on the input of the various data. Machine learning relies on training data to simulate various inputs and identify the dependent outputs of those inputs.

### SUMMARY

Disclosed is a computer-implemented method to generate training data with increased fairness. The method includes identifying a set of training data comprising at least one independent variable and a dependent variable. The method also includes analyzing the set of training data to identify correlations between the at least one independent variable and the dependent variable. The method further includes. The method includes identifying at least one correlation between a first independent variable of the one or more independent variables and the dependent variable. The method also includes calculating a fairness score for each identified correlation, including for the first independent variable, against the dependent variable. The method further includes creating, based on the analyzing, a fairness profile for the set of training data. The method includes generating, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for generating statistically fair training data, in accordance with some embodiments of the present disclosure.

FIG. 2 is a block diagram of a computing environment suitable for operation of a data manager, in accordance with some embodiments of the present disclosure.

FIG. 3 is a flow chart of an example method to create a synthetic training data set, in accordance with some embodiments of the present disclosure.

FIG. 4 is a flow chart of an example method to create a fairness profile for a set of training data, in accordance with some embodiments of the present disclosure.

FIG. 5 is a flow chart of an example method to create a synthetic training data and a synthetic data fairness profile, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as generating statistically fair set of training data 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

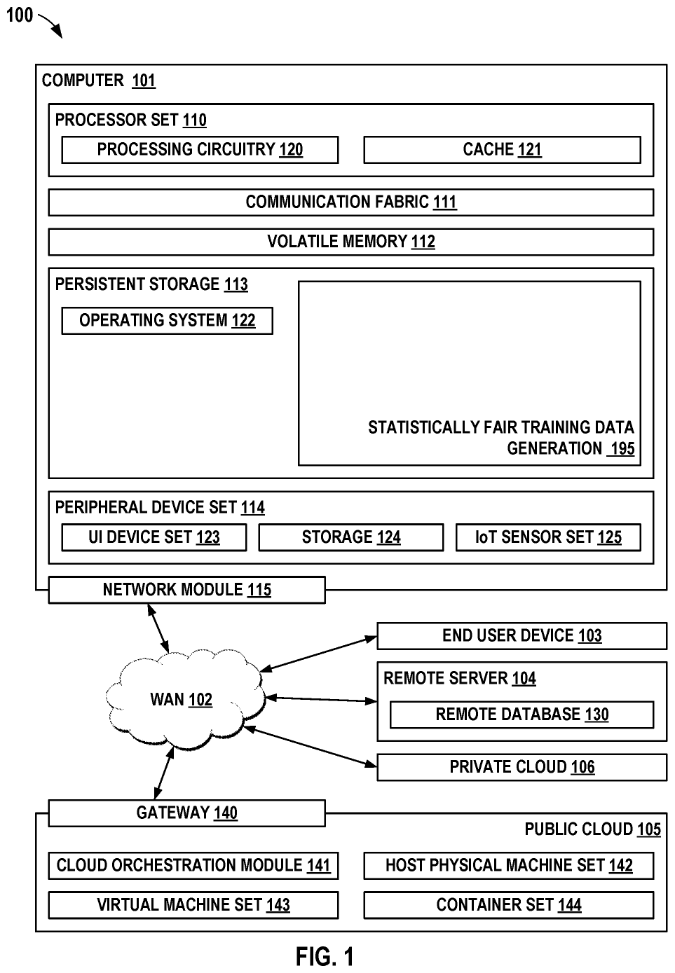

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to artificial intelligence, and, more specifically, creation of a fairness testing dataset.

Machine learning is a discipline that attempts to cause computing devices to analyze data and identify one or more conclusions and or perform one or more tasks based on the input of the various data. Machine learning relies on training data to simulate various inputs and identify the dependent outputs of those inputs. Through many iterations, machine learning models can identify trends, patterns, and conclusions that are not otherwise unavailable using traditional data analysis techniques.

However, the output of any machine learning model is fully based on the data said that is used to train it. If the training data set has incorrect and/or incomplete data, then the dependent outcome may be incorrect or undesirable for the stated goal. Ensuring training data is accurate and complete gives increased confidence the output of machine learning systems is accurate. In some cases, human and/or autonomously gathered data can include intentional or unintentional bias. For purposes of this application, bias means results and/or trends that are based on factors outside the data set. Or said differently, the bias is data that would skew the outcomes based on factors irrelevant and/or unrelated to the analysis.

In order to obtain better outputs from machine learning models, embodiments of the present disclosure can dynamically provide a dynamically generated fair training data set for various machine learning models.

Embodiments of the present disclosure include a data manager (or fairness manager). In some embodiments, the data manager generates unbiased training data. The generated data is based on a real (or unaltered) set of training data (or training data set). In some embodiments, the data manager identifies variables in the data set. Each variable can be an independent and/or dependent variable. The dependent variable can be based on one or more of the independent variables. For example, the dependent variable can be a conclusion/result of a process where each independent variable is a potential factor in that result. In some embodiments, a single variable (e.g., column) can be dependent for one process and independent (or is a factor in a later determination) for a second process. In some embodiments, the variables can be grouped into binary categories. For example, if one variable is age that has many options, the data set can be split into two groups, e.g., one group older than thirty-five years old and the second group and thirty-five years and younger.

In some embodiments, the data manager determines is there a fairness/bias level in the set of training data. The fairness can be determined by a favorable G-test (or G-test). The G-test can compare expected outcomes to actual outcomes of the independent variable groups to the dependent variable groups. The difference can be one measure of fairness in the set of training data. In some embodiments, the data manager can create a fairness profile from the training data set. The fairness profile can include the relevant variable, special variables, groupings of variables (if not binary), fairness/impact calculations, favorability metric(s), and the like.

In some embodiments, the data manager mitigates an actual or potential bias/unfairness. A generative adversarial network (GAN) can be used to mitigate unfairness. In some embodiments, the GAN can be used to create a set of generated training data. The GAN can be configured to create a set of data that has similar statistical distribution to the original set of data, but with an increased amount of fairness (or with a reduced amount of unfairness). In some embodiments, the set of training data and the fairness profile can be the inputs into the GAN.

In some embodiments, the data manager creates a generated data fairness profile. The generated data fairness profile can be similar to the fairness profile except it will be based on the generated set of training data vs. the original training data. The generated training data can be used to train and/or fine tune models to produce a fairer and more accurate outcome than the natural data would provide.

The aforementioned advantages are example advantages, and embodiments exist that can contain all, some, or none of the aforementioned advantages while remaining within the spirit and scope of the present disclosure.

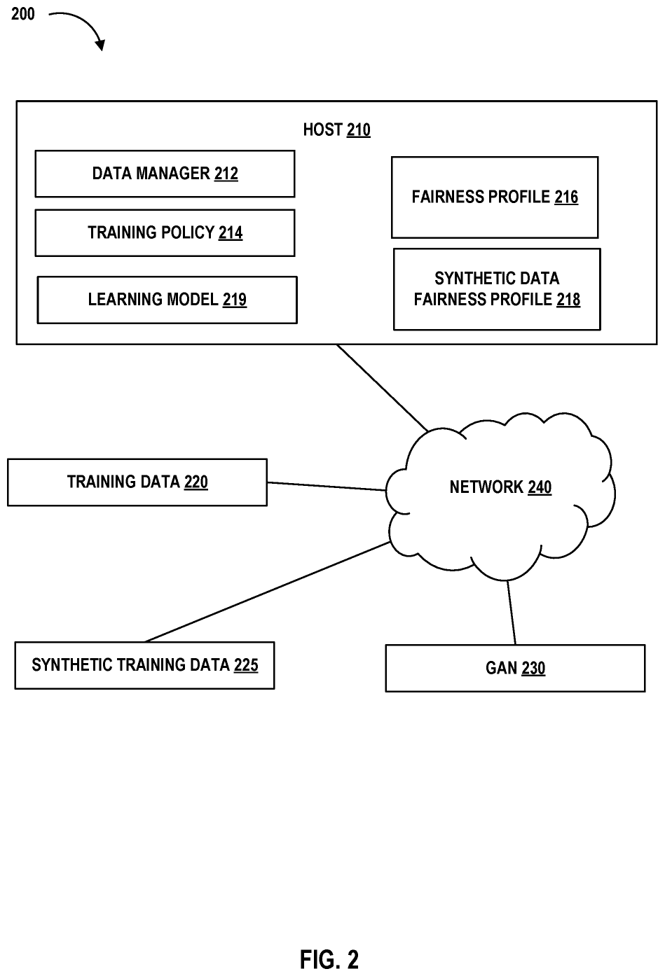

Referring now to various embodiments of the disclosure in more detail, FIG. 2 is a representation of a computing environment 200 that is capable of running a data manager in accordance with one or more embodiments of the present disclosure. Many modifications to the depicted environment may be made by those skilled in the art without departing from the scope of the disclosure.

Computing environment 200 includes host 210, training data 220, synthetic training data 225, GAN 230, and network 240. Network 240 can be, for example, a telecommunications network, a local area network (LAN), a wide area network (WAN), such as the Internet, or a combination of the three, and can include wired, wireless, or fiber optic connections. Network 240 may include one or more wired and/or wireless networks that are capable of receiving and transmitting data, voice, and/or video signals, including multimedia signals that include voice, data, and video information. In general, network 240 may be any combination of connections and protocols that will support communications between and among host 210, host 210, training data 220, synthetic training data 225, GAN 230, and other computing devices (not shown) within computing environment 200. In some embodiments, each of host 210, training data 220, synthetic training data 225, GAN 230, and other devices not shown may include one or more a computer system, such as computer 101. In some embodiments, host 210, training data 220, synthetic training data 225, and/or GAN 230 can be combined into a single computing device in any combination.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 includes data manager 212, training policy 214, fairness profiled 216, synthetic fairness profile 218 and learning model 219.

Data manager 212 can be any combination of hardware and/or software configured to generate synthetic training data. In some embodiments, the synthetic training data (or generated training data) is based on the set of training data (e.g., training data 220) and/or a fairness profile (e.g., fairness profile 216) of the set of training data. The synthetic training data can be generated to be statically similar to the set of data and to eliminate unfairness that is identified in the set of training data.

Training policy 214 is a policy to assist data manager 212 in identifying unfairness in a set of training data. For purposes of this application, unfairness and bias can be used interchangeably. In some embodiments, training policy 214 can include one or more key attributes (or significant attributes, or special attributes, or protected attributes). The key attributes can be particular for each set of training data and/or selected for a particular analysis. In some embodiments, the key attributes are based on one or more of company policy, law, regulation, malfunctions (e.g., sensor drift/failure, sensor incorrect settings), transcriptions errors, incomplete data, mislabeled data, and the like. In some embodiments, key attributes are based on the outcome of the various analysis. Any outcome that has a statical significance of possible bias int eh data can be key attributes. In some embodiments, the key attributes are based on the results of a fairness analysis. Any attribute with a fairness score, (or unfairness score) above a threshold can be a key attribute. Attributes can be based on category (or column) of data in the set of training data. In some embodiments, training policy 214 can instruct which attributes to check for bias. Training policy 214 can include threshold data. The threshold data can be related to fairness scores, data similarity scores, and the like. In some embodiments, training policy 214 includes instruction on categorizing and/or grouping/organizing multiple option attributes into a binary grouping.

Fairness profile 216 is an output of a fairness analysis of the set of training data, such as training data 220. Fairness profile 216 can include each attribute (or variable), variable type, statistical analysis results, group designations, result designations, fairness scores, and the like. Fairness profile can be based on the results of a fairness analysis by data manager 212. Each independent variable can be tested against the dependent variable to identify unfairness. In some embodiments, fairness profile 216 is an input into GAN 230 to generate synthetic training data. The input can be to train and/or test GAN 230.

Synthetic fairness profile 218 is an output of a fairness analysis of a synthetic set of training data, such as synthetic training data 225. In some embodiments, synthetic fairness profile 218 can be consistent with fairness profile 216 except it is based on the synthetic set of training data.

Learning model 219 can be any learning model configured to generate a result. In some embodiments learning model 219 is developed to be trained with training data 220 and/or synthetic training data 225. Additional information about learning models in general is described below in relation to GAN 230. In some embodiments, learning model 219 can be used to generate results after training with synthetic training data 225.

Training data 220 can be any set of data that can be used to train one or more learning models. The learning model can be of any type and/or method of learning model. In some embodiments, training data 220 includes at least one independent variable and one dependent variable. In various embodiments, the key attributes can be independent variables and/or dependent variables.

Synthetic training data 225 can be any set of data that is at least partially synthetic data. Synthetic data can be data that is generated by a learning model, in contrast data that is recorded from an event (e.g., input by a human, captured by a sensor, etc.). In some embodiments, the learning model is GAN 230. In some embodiments, synthetic training data 225 is based on training data 220, with a higher fairness score for at least one independent attribute in the data.

GAN 230 can be any combination of hardware and/or software configured to generate synthetic data.

In some embodiments, GAN 230 is trained by data in training data 220 and/or fairness profile 216. In some embodiments, GAN 230 can include a generative adversarial model. A GAN is a machine learning system that includes two neural networks, a generating network, and a validating network. The two neural networks compete with each other. The validating network (or discriminator) may be a classifier type network, and it will evaluate data. The generating network generates data such that the discriminator interprets the data in a specific way.

The discriminator is a neural network configured to determine if data is valid or invalid (relevant or irrelevant). For example, the discriminator can determine if data is consistent with training data 220. In some embodiments, the discriminator can determine if the data that is output from a set of data sent through a learning model is valid or invalid.

The generator is a neural network configured to generate data. In some embodiments, the generated data predicts data that is similar to data in training data 220. The generated data is intended to imitate the independent and/or dependent variable in training data 220.

The generator and discriminator work symbiotically to better both determine whether the output of data is correct data, and to generate data that would be determined to be correct data by the discriminator. During training, the generator generates a set of data for the various attributes based on inputs from training data 220 and fairness profile 216. The discriminator can determine if the data is good or bad data, where good or bad data means data that will give a similar result and have a statistical similar distribution, but with increased fairness. At times, the generator will choose a bad data point (that represents data that is not actual data), and the discriminator will determine that the data point is bad data. This is later used by the generator to better predict acceptable values. In some embodiments, the output of GAN 230 is synthetic training data 225.

In some embodiments, GAN 230, the generator, and/or the discriminator may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, GAN 215 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

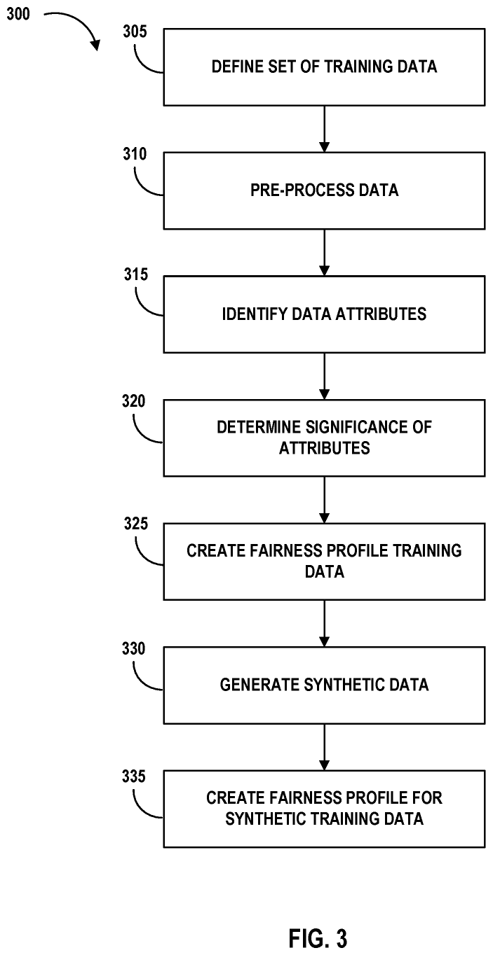

FIG. 3 is a flowchart of an example process 300 for generating a set of synthetic training data with increased fairness that can be performed in a computing environment (e.g., computing environment 100 and/or computing environment 200). One or more of the advantages and improvements described above for updating a display in a vehicle may be realized by process 300, consistent with various embodiments of the present disclosure.

Process 300 can be implemented by one or more processors, host 210, data manager 212, training policy 214, learning model 219, fairness profile 216, synthetic data fairness profile 218, training data 220, synthetic training data 225, GAN 230, and/or a different combination of hardware and/or software. In various embodiments, the various operations of process 400 are performed by one or more of host 210, data manager 212, training policy 214, learning model 219, fairness profile 216, synthetic data fairness profile 218, training data 220, synthetic training data 225, and GAN 230. For illustrative purposes, the process 400 will be described as being performed by data manager 212.

At operation 305, data manager 212 identifies a set of training data. In some embodiments, the set of training data can be any data that can be used to train learning model 219. In some embodiments, the set of training data is training data 220.

At operation 310, data manager 212 pre-processes the set of training data. In some embodiments, the pre-processing includes changing the data into a form that can be used for training.

At operation 315, data manager 212 identifies the attribute type for each attribute/variable. In some embodiments, each attribute is determined to be independent and/or dependent. The dependent attributes are based on one or more of the independent attributes. In some embodiments, each attribute is determined to be one variable form of binary, continuous, or categorical. A binary attribute/variable is an attribute that has two options. Some examples of binary attributes include, but are not limited to yes and no, on and off, approved and not approved, and the like. A continuous attribute can be an attribute that has a broad range of answers. Age and income are some examples of continuous variables. Categorical variables have three or more distinct options. Categorical variables are similar to binary, but have three or more options versus two. Some examples can include months, occupation, degree, and the like.

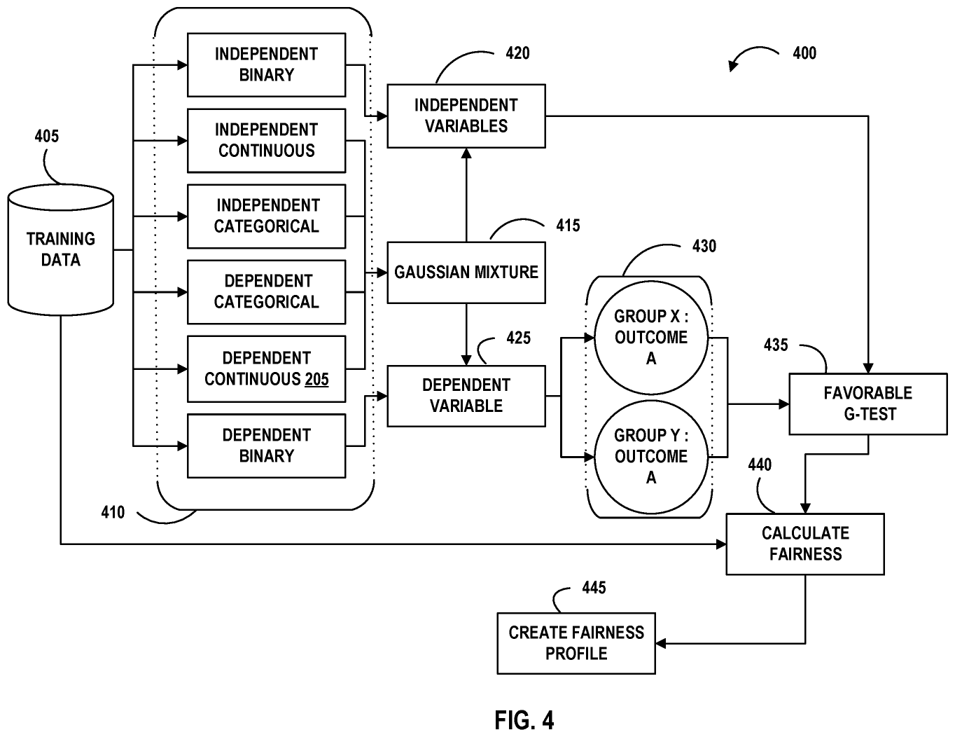

At operation 320, data manager 212 determines a significance of the attributes. In some embodiments, fairness is determined for one or more, up to all, independent attributes. In some embodiments, the fairness determination includes performing the favorable G-test. The favorable G-test is discussed in further detail below in relation to FIG. 4. In some embodiments, the fairness determination includes comparing expected outcomes to observed outcomes. The outcomes can be considered favorable or unfavorable. If the output is a number, then a setpoint can be added to distinguish between the two categories.

At operation 325, data manager 212 creates a fairness profile for the set of training data. The fairness profile can be fairness profile 216. Method 400 contains additional details on generating the fairness profile.

At operation 330, data manager 212 generates synthetic training data. In some embodiments, the synthetic training data is synthetic training data 225. In some embodiments, the synthetic training data can be generated by GAN 230. In some embodiments, the synthetic training data can be configured to mimic distributions of the training data, but with reduced unfairness (or increased fairness). Method 400 and 500 include additional details on generation of synthetic training data.

At operation 335, data manager 212 creates a synthetic training data fairness profile. In some embodiments, the synthetic training data fairness profile can be synthetic training data fairness profile 218. In some embodiments, synthetic training data fairness profile 218 is consistent with the training data fairness profile with the additional data of the differences in the various data points between the two data sets.

In some embodiments, operation 335 includes using the synthetic training data to train one or more learning models such as learning model 219. The training can provide for more fair outcomes of the learning model without needing to manually alter the original training data or gather additional training data.

FIG. 4 is a flowchart of an example process 400 for identifying fairness in a set of training data and generating a fairness profile. Process 400 shows the data flow path for various portions of the data. In some embodiments, some of steps of method 400 can be consistent with one or more operations of method 300. One or more of the advantages and improvements described above may be realized by process 400, consistent with various embodiments of the present disclosure.

Process 400 can be implemented by one or more processors, host 210, data manager 212, training policy 214, learning model 219, fairness profile 216, synthetic data fairness profile 218, training data 220, synthetic training data 225, GAN 230, and/or a different combination of hardware and/or software. In various embodiments, the various operations of process 400 are performed by one or more of host 210, data manager 212, training policy 214, learning model 219, fairness profile 216, synthetic data fairness profile 218, training data 220, synthetic training data 225, and GAN 230. For illustrative purposes, the process 400 will be described as being performed by data manager 212.

Method 400 start with training data 405. In some embodiments, training data can be consistent with training data 205. In some embodiments, one or more focus attributes/variables are indicated. The indication can provided within training the training data 205. The focus attributes can be identified based on information on training policy 214 and/or additional user input. In some embodiments, the fairness analysis is performed on one or more of the identified focus variables.

At 410, the variables are categorized. Each variable is categorized as either binary, continuous, or categorical, and as independent or dependent. Variable categorization and/or identification can be consistent with operation 310 and 315 of method 300.

At 415, the categorical and continuous variables are run through a gaussian mixture model (GMM). A GMM is a probabilistic model for representing distributed subpopulations within an overall population. In some embodiments, the gaussian mixture transforms the categorical and continuous variable into binary variables.

For categorical variables, each choice for the variable is placed into one of two groups. For example, if the categories included values of A, B, and C, after the gaussian mixture, two of the variables will be grouped together as group X, and the third separately as group Y. In some embodiments, hot encoding is used to group the variables. This includes converting the variable into binary vectors. Once the categorical variables are converted into binary vectors using one-hot encoding, the GMM models the probability density function as a mixture of Gaussian distributions. The parameters for the GMM are the mixture components, mean vector, covariance matrix, and the mixing weights. The mixture component is 2. The unknown parameters of the GMM are estimated from the observed data through an expectation-maximization (EM) algorithm.

For continuous variables, the GMM converts into a categorical variable with 2 factors. In some embodiments, the GMM models the probability density function as a mixture of Gaussian distributions. The parameters for the GMM are the mixture components, mean vector, covariance matrix, and the mixing weights. The mixture component is 2. The unknown parameters of the GMM are estimated from the observed data through expectation-maximization (EM) algorithm. Initially, the unknown parameters are chosen randomly and iteratively updated using the EM algorithm. The EM algorithm alternates between estimating the probability that each data point belongs to a specific mixture component and updating the model parameters based on the data point's belonging. This process continues until the likelihood of the observed data no longer increases significantly. Once the GMM is trained, the mixture components can be used to create the binned categorical variable through assigning each data point to the mixture component with the highest responsibility for that data point. For example, as a result, the two groups can be age twenty and younger, and twenty-one and older.

At 420, all independent variables are converted into binary, and at 425, all dependent variables are converted to binary. At 430, the binary outcomes of the dependent variable are linked to one of the two possible outcomes. For example, the outcome can be outcome A or outcome B. The bin in which the outcome falls is based on the output of the learning model. For each outcome, the opposite variable is paired with the same output. For example, in one circle, group X is paired with outcome A and group Y is paired with outcome B. In the second circle, group Y is paired with outcome A and group X is paired with outcome B. Outcomes A and B can be given additional labels such as desired/undesired, positive/negative, favorable/unfavorable, and the like. In all cases, each outcome A and outcome B will be representative of one or more variable values based on the training data.

At 435, the Favorable G-test is performed (G-test). In some embodiments, the G-test is one way to measure statistical relationships between the groups (e.g., group X and group Y) and the outcomes. The G-test is a non-parametric likelihood ratio test that compares observed frequencies of categorical variables with the expected frequencies. In the present process, the frequencies are compared based on a specified outcome (e.g., outcome A). The null hypothesis assumes that there is no significant difference between the observed and expected frequencies; the alternative hypothesis assumes that there is a significant difference. This methodology applies a generalization of the chi-squared test and can be used when sample sizes are small. In some embodiments, Equation 1 is used:

$$2 * ( A * ln ( \frac{A}{Ea} ) ) + ( B * ln ( \frac{B}{Eb} ) ) \qquad Equation 1$$

where:
Ea is the expected value of favorable outcomes for group A;
Eb is the expected value of favorable outcomes for group B;
A is the number of observations in group A and favorable category; and
B is the number of observations in group B and favorable category.

The output of Equation 1 can be used to determine the fairness of the input variable. If the value exceeds a predetermined threshold, then it is considered a statically significant indication of unfairness.

A fairness score is calculated at 440. In some embodiments, the fairness score is based on a ratio of a specified outcome (e.g., outcome A). In some embodiments, the fairness is measured by determining a disparate impact. The disparate impact is computed as the ratio of rate of specified outcomes (outcome A) for one group (e.g., group X) to the other group (e.g., group Y). The ideal value of this metric is 1.0. A value <1 implies higher benefit for the group X and a value >1 implies a higher benefit for group Y. This metric is calculated for each variable. If this metric falls outside of the 80% rule, then there is bias present in that protected attribute. The 80% rule states that if a selection rate for a particular group is less than 80% with respect to the group with the highest selection rate, the selection process may be considered unfair. The 80% rule is commonly used within AI Governance. This threshold is configurable and can be changed based on each use-case.

The fairness can be calculated for each independent variable against each dependent variable. At 445, a fairness profile (e.g., fairness profile 216) is generated to capture the output of method 400 for each variable. This output can include which variables have unfairness in the training data set. In some embodiments, the fairness profile includes, for each variable, the variable, the variable type, whether it is a key attribute, whether there is a statistical significance between the dependent variable and the referenced independent variable, group labels, disparate impact, and the like.

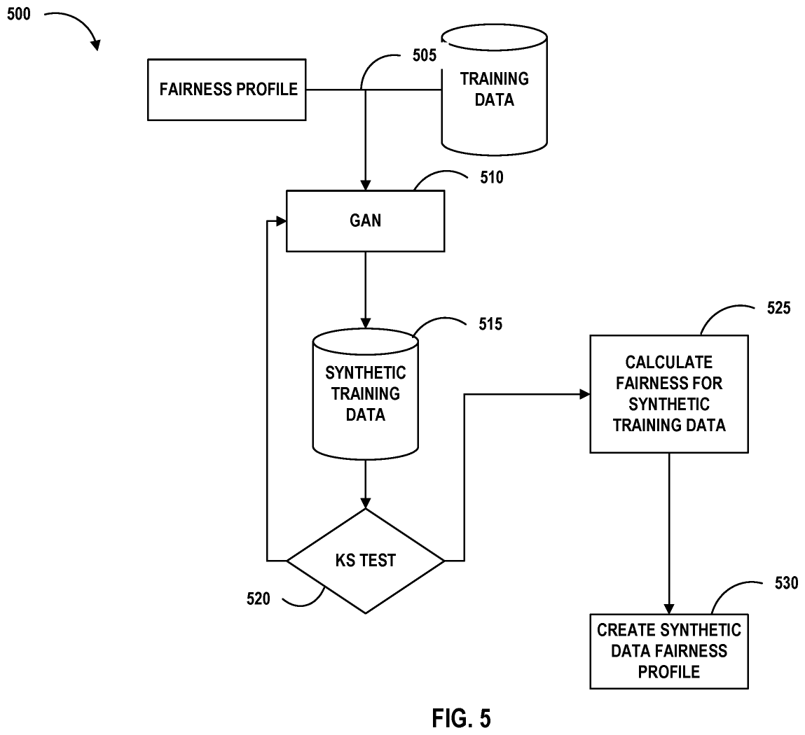

FIG. 5 is a flowchart illustrating one embodiment of an example method 500 for generating a synthetic set of training data, based on the fairness profile and the set of training data. Process 500 shows the data flow path for various portions of the data. In some embodiments, some of the operations of method 400 can be consistent with one or more operation of method 300. One or more of the advantages and improvements described above may be realized by process 500, consistent with various embodiments of the present disclosure.

The method 500 can be implemented by one or more processors, host 210, data manager 212, training policy 214, learning model 219, fairness profile 216, synthetic data fairness profile 218, training data 220, synthetic training data 225, GAN 230, and/or a different combination of hardware and/or software. In various embodiments, the various operations of process 400 are performed by one or more of host 210, data manager 212, training policy 214, learning model 219, fairness profile 216, synthetic data fairness profile 218, training data 220, synthetic training data 225, and GAN 230. For illustrative purposes, the process 500 will be described as being performed by data manager 212.

At 505, fairness profile and the set of training data are fed into a GAN. The fairness profile can be the fairness profile generated in method 400 and/or fairness profile 216. The training data can be training data 220 and the same set of training data used in method 400. The GAN can be GAN 230.

At 510, the GAN generates synthetic data points and outputs it to synthetic training data at 515. The synthetic training data at 515 can be consistent with synthetic training data 225.

In some embodiments, the GAN comprises of one generator (G1) and two discriminators (D1) and (D2). In some embodiments, each generated sample has a corresponding value of the disparate attribute. The generator generates synthetic data based on conditional distribution of the original data set with a noise component. So, the synthetic data is based on a joint distribution of the original data and the disparate value of the referenced attribute. The D1 is trained to distinguish between the real data from training data 220 and synthetic data generated by G1.

An additional constraint is added to G1: a fairness constraint. This is configured to remove the statistical link found by the G-test. D2 is incorporated into the GAN and trained to distinguish the two categories of generated samples for the two potential outcomes. D2 is conditioned on the disparate attributes for which unfairness is detected. In some embodiments, an adjustable tuning parameter can be inserted that balances the removal of unfairness and/or the utility of the data for training and useful purposes.

At 520 the synthetic data set is compared to the original data set. In some embodiments, the Kolmogorov-Smirnov test (KS test) is used to compare the data set. In some embodiments, the KS test compares distributions by considering the cumulative distribution of the groups under consideration. The KS test can determine the maximum absolute difference between two cumulative distributions. In some embodiments, a KS threshold can be used to determine if the difference is significant.

If the KS test result is below the KS threshold, then it can be treated as if the datasets come from the same underlying distributions. Said differently, the synthetic training data will produce similar results (within the accepted error based on the threshold) as the training data, but with the unfairness removed for the referenced variables.

If the KS test result is above the KS threshold, then this indicates the synthetic training data is too dissimilar from the training data. The GAN can continue to generate new synthetic data based on the outcome of the KS test. In some embodiments, the tuning parameter can be adjusted to alter the synthetic training data.

At 525, fairness is calculated for the synthetic training data. In some embodiments, the fairness calculation for the synthetic training data is consistent with the fairness calculation in method 400 steps 405-440.

At 530, a synthetic data fairness profile is generated. In some embodiments, the synthetic data fairness profile is consistent with the training data fairness profile of method 400, 445. In some embodiments, the synthetic data fairness profile includes additional data, such as differences from the training data fairness profile (for any or all columns).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In summary, various embodiments have been discussed which are again specified in the following numbered examples:

Example 1 is as follows. A computer-implemented method comprising: identifying a set of training data comprising at least one independent variable and a dependent variable; analyzing the set of training data to identify correlations between the at least one independent variable and the dependent variable; identifying at least one correlation between a first independent variable of the one or more independent variables and the dependent variable; calculating a fairness score for each identified correlation, including for the first independent variable, against the dependent variable; creating, based on the analyzing, a fairness profile for the set of training data; and generating, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold. This provides a benefit of data that will increase the fairness of a data set used to train a model.

Example 2 is as follows. The method of example 1, where the synthetic set of training data includes the at least one independent variable and the dependent variable, the method further comprising: recalculating the fairness score for the synthetic set of training data; and creating a synthetic data fairness profile for the synthetic set of training data, where the synthetic data fairness profile includes changes in the fairness score.

Example 3 is as follows. The method of examples 1 or 2, further comprising: determining, using a Kolmogorov-Smirnov (KS) test, a difference in a cumulative distribution between set of training data and the synthetic set of training data is below a distribution threshold.

Example 4 is as follows. The method of any of the preceding examples, where the cumulative distribution being below the distribution threshold indicates the set of training data and the synthetic set of training data are from a common set of data. This ensures that the synthetic data is statistically similar to the original training data. This also ensures that the results are not changed, or stated differently, that different outcomes are not produced for the previously fair variables.

Example 5 is as follows. The method of any of the preceding examples, where the at least one correlation is based on comparing an expected outcome to an actual outcome for the at least one independent variable to the dependent variable.

Example 6 is as follows. The method of any of the preceding examples, where each variable is converted to a binary variable by a gaussian mixture model, and the correlation is further based on comparing includes analyzing both independent input groups against both dependent output groups.

Example 7 is as follows. The method of any of the preceding examples, further comprising: training the learning model with the synthetic set of training data.

Example 8 is as follows. The method of any of the preceding examples, where the GAN comprises a generator, a first discriminator, and a second discriminator. The second discriminator allows for validation the generated data will lead to similar outcomes as the real data, but with the increased fairness.

Example 9 is as follows. The method of any of the preceding examples, where the first discriminator is configured to identify synthetic training data, and the second discriminator is configured to identify correct outcome of the dependent variable based on inputs of the one or more independent variables.

Example 10 is as follows. The method of any of the preceding examples, where the generator is configured to generate the inputs of the one or more independent variable associated with a generated outcome.

Example 11 is as follows. A system comprising: a processor; and a computer-readable storage medium communicatively coupled to the processor and storing program instructions which, when executed by the processor, are configured to cause the processor to: identify a set of training data comprising at least one independent variable and a dependent variable; analyze the set of training data to identify correlations between the at least one independent variable and the dependent variable; identify at least one correlation between a first independent variable of the one or more independent variables and the dependent variable; calculate a fairness score for each identified correlation, including for the first independent variable, against the dependent variable; create, based on the analyzing, a fairness profile for the set of training data; and generate, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold. This provides a benefit of data that will increase the fairness of a data set used to train a model.

Example 12 is as follows. The system of example 11, where the synthetic set of training data includes the at least one independent variable and the dependent variable, and the program instructions are further configured to cause the processor to: recalculate the fairness score for the synthetic set of training data; and create a synthetic data fairness profile for the synthetic set of training data, where the synthetic data fairness profile includes changes in the fairness score.

Example 13 is as follows. The system of examples 11 or 12, where the program instructions are further configured to cause the process to: train the learning model with the synthetic set of training data.

Example 14 is as follows. The system of examples 11 to 13, where the at least one correlation is based on comparing an expected outcome to an actual outcome for the at least one independent variable to the dependent variable.

Example 15 is as follows. The system of examples 11 to 14, where the GAN comprises a generator, a first discriminator, and a second discriminator.

Example 16 is as follows. A computer program product, the computer program product comprising a computer readable storage medium having program instructions embodied therewith, the program instructions executable by a processing unit to cause the processing unit to identify a set of training data comprising at least one independent variable and a dependent variable; analyze the set of training data to identify correlations between the at least one independent variable and the dependent variable; identify at least one correlation between a first independent variable of the one or more independent variables and the dependent variable; calculate a fairness score for each identified correlation, including for the first independent variable, against the dependent variable; create, based on the analyzing, a fairness profile for the set of training data; and generate, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold. This provides a benefit of data that will increase the fairness of a data set used to train a model.

Example 17 is as follows. The computer program product of example 16, where the synthetic set of training data includes the at least one independent variable and the dependent variable, the program instructions are further configured to cause the processing unit to: recalculate the fairness score for the synthetic set of training data; and create a synthetic data fairness profile for the synthetic set of training data, where the synthetic data fairness profile includes changes in the fairness score.

Example 18 is as follows. The computer program product of examples 16 or 17, where the program instructions are further configured to cause the processing unit to: train the learning model with the synthetic set of training data.

Example 19 is as follows. The computer program product of examples 16 to 19, where the at least one correlation is based on comparing an expected outcome to an actual outcome for the at least one independent variable to the dependent variable.

Example 20 is as follows. The computer program product of examples 16 to 19, where the GAN comprises a generator, a first discriminator, and a second discriminator.

What is claimed is:

1. A computer-implemented method comprising:
identifying a set of training data comprising at least one independent variable and a dependent variable;
analyzing the set of training data to identify correlations between the at least one independent variable and the dependent variable;
identifying at least one correlation between a first independent variable of the one or more independent variables and the dependent variable;
calculating a fairness score for each identified correlation, including for the first independent variable, against the dependent variable;
creating, based on the analyzing, a fairness profile for the set of training data; and
generating, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold.

2. The computer-implemented method of claim 1, wherein the synthetic set of training data includes the at least one independent variable and the dependent variable, the method further comprising:
recalculating the fairness score for the synthetic set of training data; and
creating a synthetic data fairness profile for the synthetic set of training data, wherein the synthetic data fairness profile includes changes in the fairness score.

3. The computer-implemented method of claim 2, further comprising:
determining, using a Kolmogorov-Smirnov (KS) test, when a difference in a cumulative distribution between the set of training data and the synthetic set of training data is below a distribution threshold.

4. The computer-implemented method of claim 3, wherein the cumulative distribution being below the distribution threshold indicates the set of training data and the synthetic set of training data are from a common set of data.

5. The computer-implemented method of claim 1, wherein the at least one correlation is based on comparing an expected outcome to an actual outcome for the at least one independent variable to the dependent variable.

6. The computer-implemented method of claim 5, wherein each variable is converted to a binary variable by a gaussian mixture model, and the correlation is further based on a comparing that includes analyzing both independent input groups against both dependent output groups.

7. The computer-implemented method of claim 1, further comprising:
training the learning model with the synthetic set of training data.

8. The computer-implemented method of claim 1, wherein the GAN comprises a generator, a first discriminator, and a second discriminator.

9. The computer-implemented method of claim 8, wherein the first discriminator is configured to identify synthetic training data, and the second discriminator is configured to identify a correct outcome of the dependent variable based on inputs of the one or more independent variables.

10. The computer-implemented method of claim 9, wherein the generator is configured to generate the inputs of the one or more independent variable associated with a generated outcome.

11. A system comprising:
a processor; and
a computer-readable storage medium communicatively coupled to the processor and storing program instructions which, when executed by the processor, are configured to cause the processor to:
identify a set of training data comprising at least one independent variable and a dependent variable;
analyze the set of training data to identify correlations between the at least one independent variable and the dependent variable;
identify at least one correlation between a first independent variable of the one or more independent variables and the dependent variable;
calculate a fairness score for each identified correlation, including for the first independent variable, against the dependent variable;
create, based on the analyzing, a fairness profile for the set of training data; and
generate, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold.

12. The system of claim 11, wherein the synthetic set of training data includes the at least one independent variable and the dependent variable, and the program instructions are further configured to cause the processor to:
recalculate the fairness score for the synthetic set of training data; and
create a synthetic data fairness profile for the synthetic set of training data, wherein the synthetic data fairness profile includes changes in the fairness score.

13. The system of claim 12, wherein the program instructions are further configured to cause the process to:
train the learning model with the synthetic set of training data.

14. The system of claim 11, wherein the at least one correlation is based on comparing an expected outcome to an actual outcome for the at least one independent variable to the dependent variable.

15. The system of claim 11, wherein the GAN comprises a generator, a first discriminator, and a second discriminator.

16. A computer program product, the computer program product comprising a computer readable storage medium having program instructions embodied therewith, the program instructions executable by a processing unit to cause the processing unit to:
identify a set of training data comprising at least one independent variable and a dependent variable;
analyze the set of training data to identify correlations between the at least one independent variable and the dependent variable;
identify at least one correlation between a first independent variable of the one or more independent variables and the dependent variable;
calculate a fairness score for each identified correlation, including for the first independent variable, against the dependent variable;
create, based on the analyzing, a fairness profile for the set of training data; and
generate, by a generative adversarial network (GAN) and based on the set of training data and the fairness profile, and in response to the first fairness score being below a fairness threshold, a set of synthetic training data, wherein the GAN is configured to increases the fairness score for the first independent variable with above a fairness threshold.

17. The computer program product of claim 16, wherein the synthetic set of training data includes the at least one independent variable and the dependent variable, the program instructions are further configured to cause the processing unit to:
recalculate the fairness score for the synthetic set of training data; and
create a synthetic data fairness profile for the synthetic set of training data, wherein the synthetic data fairness profile includes changes in the fairness score.

18. The computer program product of claim 16, wherein the program instructions are further configured to cause the processing unit to:
train the learning model with the synthetic set of training data.

19. The computer program product of claim 16, wherein the at least one correlation is based on comparing an expected outcome to an actual outcome for the at least one independent variable to the dependent variable.

20. The computer program product of claim 16, wherein the GAN comprises a generator, a first discriminator, and a second discriminator.
